(19) United States
(12) Patent Application Publication
(10) Pub. No.: US 2003/0128183 A1
(43) Pub. Date: Jul. 10, 2003

(54) Overhead LCD monitor in combination with a DVD player for a vehicle

(76) Inventor: Steven Chang, Chung Ho City (TW)

Correspondence Address: HELLER EHRMAN WHITE & MCAULIFFE LLP, 275 MIDDLEFIELD ROAD, MENLO PARK, CA, 94025-3506, US

(21) Appl. No.: 10/038,938

(22) Filed: Jan. 4, 2002

(51) Int. Cl. G09G 5/00

(52) U.S. Cl. 345/156

(57) ABSTRACT

An overhead monitor in combination with a DVD player includes a fixed plate adapted to be mounted in a ceiling of an automobile and provided with a concave area and a recessed area defined in a bottom face defining the concave area to receive therein the DVD player and a moving plate pivotally connected to the fixed plate and having the monitor embedded therein. The DVD player has a cover with a wedge and an extension, a clamp and a hole with a sensor received therein are defined in a face of the concave area to respectively correspond to the wedge and the extension, so that only when the cover securely engages the face of the concave area, can the DVD player be operated normally.

### BACKGROUND OF THE INVENTION

1. Field of the Invention

The present invention relates to an overhead monitor in combination with a DVD player for a vehicle, and more particularly to an overhead monitor having a DVD player securely received inside the monitor so as to be compact for storage.

2. Description of Related Art

In order to enjoy high quality images, most auto-drivers have a liquid crystal display (LCD) mounted onboard. The LCD normally is held on the ceiling of the car so that passengers are able to watch their favorite movies while they are onboard. However, when the user wants to watch a different DVD (digital video disk) from one that has just been shown, the passengers will have to actually go to another place in the car to have the access to the DVD that is being played. To save trouble for the user moving around in a moving car which can impair the steering of the car and the cost which arises from the wires necessary to transmit signals, a monitor in combination with a DVD player is invented and introduced to the market. This kind of displaying unit saves a lot of trouble for the user because there is no need for extra wires to transmit signals from the DVD player to the monitor. However, the DVD player is mounted in a recess in the monitor after the monitor is installed on the ceiling. Therefore, manual effort is still necessary to install the DVD player in the monitor. Moreover, the signal wires are still required for the monitor and the DVD player respectively. That is, though the entire length of the signal wires is reduced, the signal wires are provided respectively to the monitor and the DVD player. Thus, cost for such a structure is still high.

To overcome the shortcomings, the present invention tends to provide an improved overhead monitor in combination with a DVD player which shares the same printed circuit board (PCB) with the monitor to mitigate and obviate the aforementioned problems.

### SUMMARY OF THE INVENTION

The primary objective of the present invention is to provide an overhead monitor in combination with a DVD player. The DVD player shares with the monitor a printed circuit board so that there are no signal wires needed to communicate the DVD player with the monitor.

Another objective of the present invention is to provide an overhead monitor in combination with a DVD player. The combination is compact in size and has high quality image due to the elimination of transforming signals from analog to digital between the monitor and the DVD player and vice versa.

Still another objective of the present invention is to provide a safety device inside the DVD player so that only when the cover of the DVD player is closed, can the DVD player be operated.

In order to accomplish the foregoing objective, the combination of the monitor and the DVD player has a fixed plate with a DVD player embedded therein and a moving plate pivotally connected to the fixed plate and having a monitor received therein. The fixed plate further has a concave area with a depth equal to a thickness of the combination of the moving plate and the monitor, so that when the combination of the moving plate and the monitor pivots relative to the fixed plate and received in the recessed area, a purpose of compact size is achieved.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the combination of the monitor and the DVD player;

FIG. 2 is a perspective view of the monitor in combination with the DVD player shown in FIG. 1, wherein the cap of the DVD player is open for easy illustration;

FIG. 3 is a side plan view in partial section showing a safety device mounted in the combination of the monitor and the DVD player;

FIG. 4 is a side plan view in partial section showing the safety device is in engagement to allow the DVD player to operate;

FIG. 5 is a side plan view showing that when the monitor is in engagement with the DVD player, a protective cap is lowered to protect the transmission device; and

FIG. 6 is a side plan view showing that when the monitor is in disengagement with the DVD player, the protective cap is simultaneously raised to allow the pivotal movement of the moving plate.

### DETAILED DESCRIPTION OF THE PREFERRED EMBODIMENT

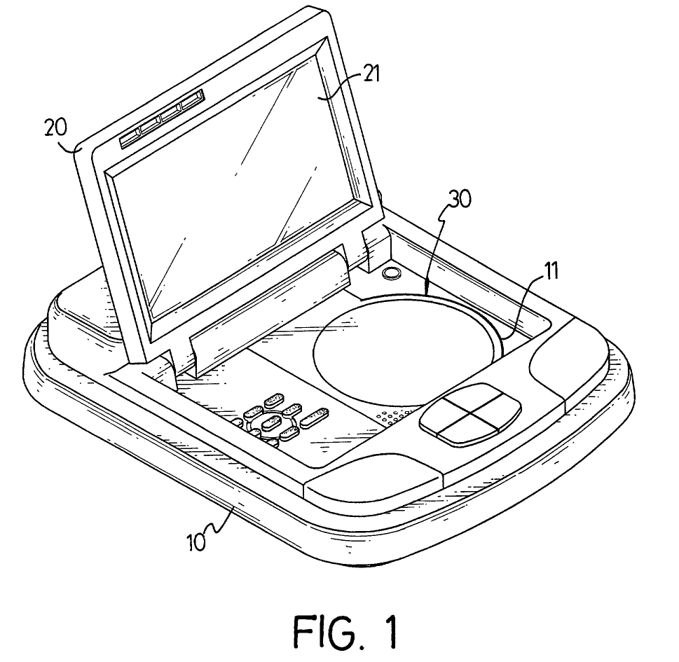

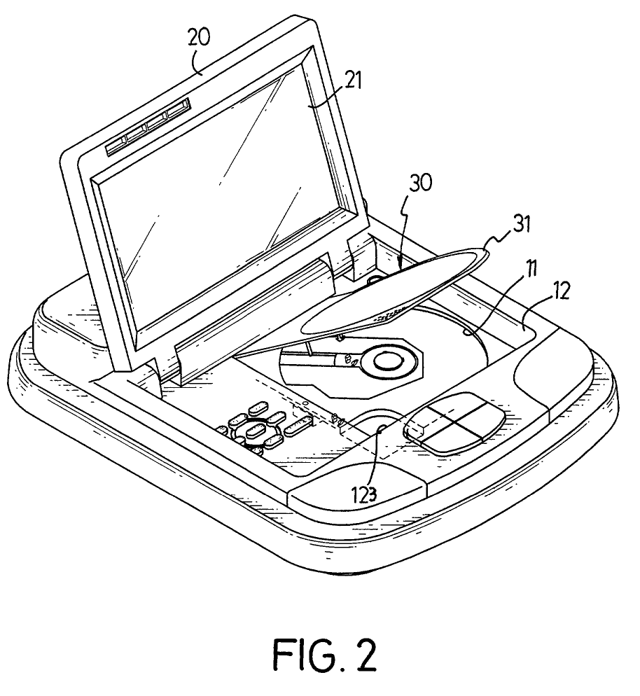

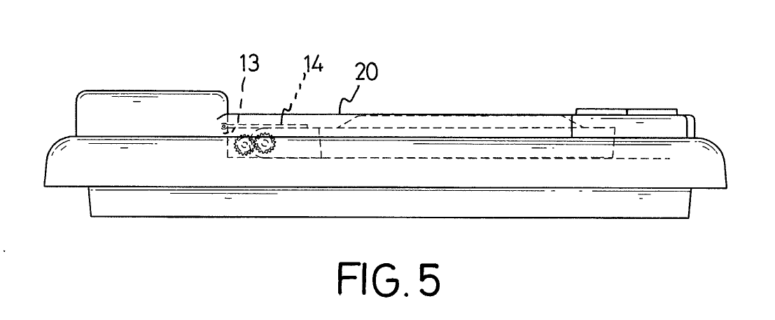

With reference to FIGS. 1 and 2, the combination of the monitor and the DVD player constructed in accordance with the present invention has a fixed plate (10) adapted to be mounted in the ceiling of a car and provided with a DVD player (30) embedded therein and a moving plate (20) pivotally connected to the fixed plate (10) and having an LCD monitor (21) received therein. The fixed plate (10) further has a recessed area (11) defined to securely receive therein the DVD player (30). The fixed plate (10) is further provided with a concave area (12) and the recessed area (11) is defined in a bottom defining the concave area (12). The concave area (12) has a depth equal to a thickness of the combination of the moving plate (20) and the monitor (21), so that when the combination of the moving plate (20) and the monitor (21) pivots relative to the fixed plate (10) and is received in the recessed area (11), as shown in FIG. 5, a purpose of compact size is achieved.

The DVD player (30) shares the same printed circuit board (not shown) with the monitor (21), but as the circuit connecting from the printed circuit board to the DVD player (30) and the monitor (21) is conventional in the art and is not the focus of the present invention, detailed description thereof is this omitted.

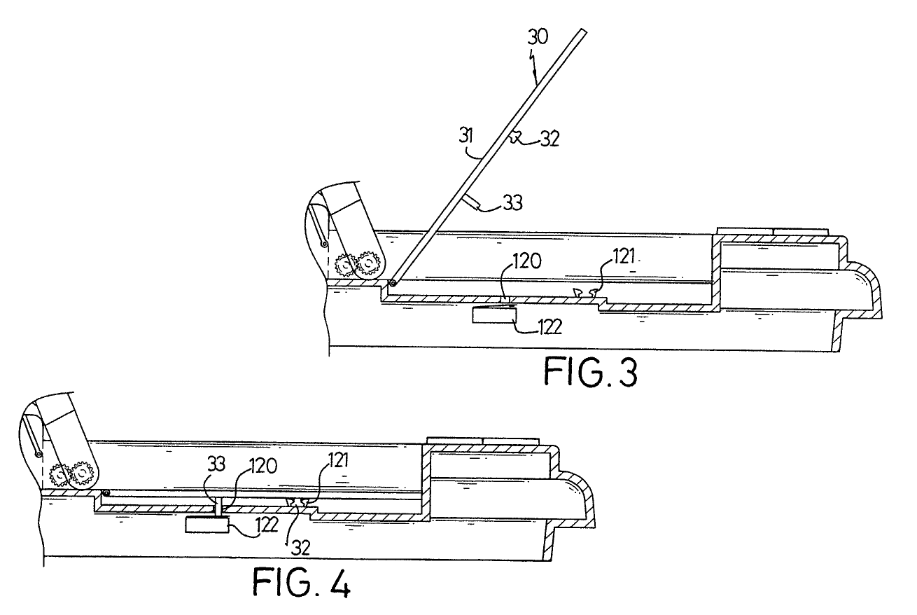

With reference to FIGS. 3 and 4, the DVD player (30) has a cover (31) pivotally connected to a body of the DVD player (30) and provided with a wedge (32) and an extension (33) formed on a bottom face of the cover (31). In contrast to the wedge (32) and the extension (33) and at the bottom face defining the concave area (12), a clamp (121) and a hole (120) are respectively formed to correspond to the wedge (32) and the extension (33). Moreover, a sensor (122) is mounted on a bottom of the fixed plate (10) to correspond to the hole (120). It is noted that only when the cover (31) is closed and the extension (33) extends into the hole (120) to engage the sensor (122), can the DVD player (30) be operated. In order to maintain the cover (31) in a closed status, the clamp (121) is able to secure the wedge (32) so that even if sa sudden bump occurs when the DVD player (30) is operated, the DVD player (30) can still operate normally.

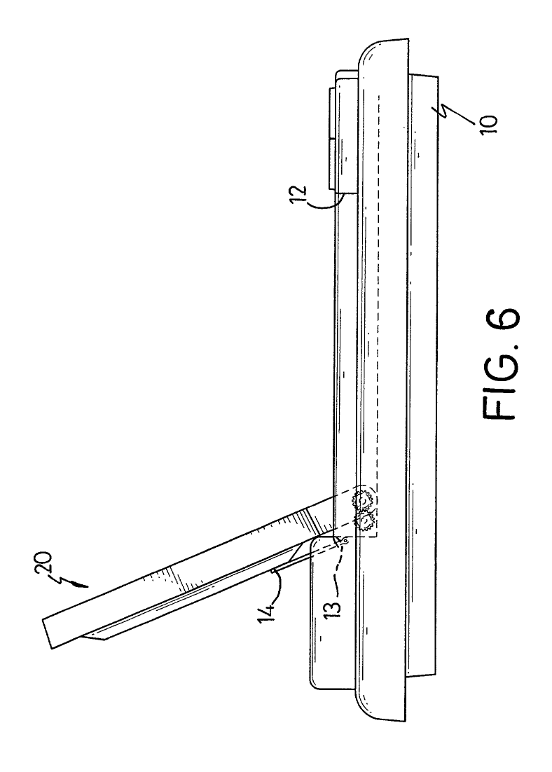

With reference to FIGS. 5 and 6, it is noted that a gap (13) defined at the joint between the fixed plate (10) and the moving plate (20) is provided to receive a transmission device (not numbered and shown in phantom line). Therefore, to protect the transmission device, a protective cap (14) is pivotally connected to an end side of the fixed plate (10). When the moving plate (20) pivots away from the fixed plate (10), the protective cap (14) will simultaneously pivot along the moving plate (20). However, when the moving plate (20) pivots toward the fixed plate (10), the protective cap (14) will also simultaneously pivot to cover the gap (13) so as to cover the transmission device which is used to provide the pivotal movement to the moving plate (20) with respect to the fixed plate (10).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An overhead monitor in combination with a DVD player used in an automobile, the overhead monitor in combination with the DVD player comprising:
a fixed plate adapted to be mounted in a ceiling of the automobile and provided with a concave area and a recessed area defined in a bottom face defining the concave area to receive therein the DVD player;
a moving plate pivotally connected to the fixed plate and having the monitor embedded therein,
wherein the DVD player has a cover with a wedge and an extension,
a clamp and a hole with a sensor received therein are defined in a face of the concave area to respectively correspond to the wedge and the extension, so that only when the cover securely engages the face of the concave area, can the DVD player be operated normally.

2. The overhead monitor in combination with a DVD player used in an automobile as claimed in claim 1 further comprising a gap defined at a joint between the moving plate and the fixed plate and a protective cap pivotally connected to the fixed plate to selectively cover the gap.

3. The overhead monitor in combination with a DVD player used in an automobile as claimed in claim 1, wherein the concave area has a depth equal to a thickness of a combination of the moving plate and the monitor so that after the combination of the moving plate and the monitor is received in the concave area, the moving plate together with the monitor is flush with the fixed plate.
